(19) United States
(12) Patent Application Publication
(10) Pub. No.: US 2017/0292393 A1
(43) Pub. Date: Oct. 12, 2017

(54) TANGENTIAL ON-BOARD INJECTORS FOR GAS TURBINE ENGINES

(71) Applicant: United Technologies Corporation, Farmington, CT (US)

(72) Inventors: Jeffrey Vincent Anastas, Kennebunk, ME (US); Michael S. Stevens, Alfred, ME (US)

(21) Appl. No.: 15/094,603

(22) Filed: Apr. 8, 2016

(51) Int. Cl. F01D 9/04; F01D 5/08

(52) U.S. Cl. CPC F01D 9/048; F01D 5/082; F01D 9/041; F05D 2220/32; F05D 2230/20; F05D 2240/128; F05D 2260/20

(57) ABSTRACT

A TOBI for a gas turbine engine having a TOBI body, a first TOBI airfoil having a radially extending portion extending from a leading edge and an axially extending portion extending toward a trailing edge, and a second TOBI airfoil circumferentially adjacent to the first TOBI airfoil, the second TOBI airfoil having a radially extending portion extending from a leading edge and an axially extending portion extending toward a trailing edge. An entrance is defined between the leading edges of the adjacent TOBI airfoils and an exit is defined between the trailing edges of the TOBI airfoils, wherein airflow entering the entrance enters in a radial direction relative to the TOBI body and airflow exiting the exit exits in a circumferential direction relative to the TOBI body.

### STATEMENT REGARDING FEDERALLY SPONSORED RESEARCH OR DEVELOPMENT

This invention was made with government support under Contract No. FA-8650-09-D-2923 0021 awarded by the United States Air Force. The government has certain rights in the invention.

### BACKGROUND

The subject matter disclosed herein generally relates to gas turbine engines and, more particularly, to tangential on-board injectors (TOBI).

Variable Area Turbines (VATs) are an adaptive component which, when coupled with other adaptive engine features such as adaptive fans, compressors with variable vanes, variable nozzles, etc. can yield significant benefits in overall gas turbine engine performance. Such benefits may include but are not limited to reduced specific fuel consumption (SFC), reduced High Pressure Compressor (HPC) discharge air temperature (T3) at take-off conditions, improved throttle response, and improved part life. A VATs function is to provide a change in turbine flow parameter (i.e., HPT flow parameter is defined as FP4, LPT flow parameter is defined as FP45). To achieve the change in flow parameter one solution is to change a turbine flow area. As the main turbine flow area meter, varying the first stage turbine vane area in any given turbine provides a prime means for varying turbine flow parameter. Varying turbine vane area may be achieved in various ways including rotating a plurality of the individual vane airfoils in the first stage in any given turbine.

Utilizing rotating turbine vanes to adjust engine by-pass ratio may affect a flow swirl angle to downstream components. The actuation of the rotating vanes alters the inlet angle to the downstream rotor row altering the stagnation location from positive incidence (pressure side stagnation location), neutral incidence (leading edge stagnation location), to negative incidence (suction side stagnation location). This also affects the revolutions per minute (RPM) of first and second blades within the gas turbine engine. In current configurations, the blades may be cooled by cooling air and that cooling air is delivered by a tangential on-board injector (TOBI) that turns the air so that the loss coming on board is minimal. Normally the air is turned in such a way that the incoming velocity is close to that of the blade itself.

### SUMMARY

According to one embodiment, a tangential on-board injector (TOBI) for a gas turbine engine is provided. The TOBI includes a TOBI body, a first TOBI airfoil disposed within the TOBI body and having a radially extending portion extending from a leading edge and an axially extending portion extending toward a trailing edge such that a flow path along the first TOBI airfoil is radially flowing at the leading edge and is transitioned to circumferentially flowing at the trailing edge, and a second TOBI airfoil circumferentially adjacent to the first TOBI airfoil, the second TOBI airfoil having a radially extending portion extending from a leading edge and an axially extending portion extending toward a trailing edge such that a flow path along the second TOBI airfoil is radially flowing at the leading edge and is transitioned to circumferentially flowing at the trailing edge. An entrance is defined between the leading edges of the adjacent TOBI airfoils and an exit is defined between the trailing edges of the TOBI airfoils, wherein airflow entering the entrance enters in a radial direction relative to the TOBI body and airflow exiting the exit exits in a circumferential direction relative to the TOBI body.

In addition to one or more of the features described above, or as an alternative, further embodiments of the TOBI may include a top wall and a bottom wall opposing the top wall, wherein the adjacent TOBI airfoils, the top wall, and the bottom wall define a passageway from the leading edges to the trailing edges.

In addition to one or more of the features described above, or as an alternative, further embodiments of the TOBI may include that the entrance is defined by a first distance between the leading edges and the exit is defined by a second distance between trailing edges, wherein the first distance is greater than the second distance.

In addition to one or more of the features described above, or as an alternative, further embodiments of the TOBI may include that the first TOBI airfoil and the second TOBI airfoil each have a uniform height such that the passageway has a uniform height extending from the entrance to the exit.

In addition to one or more of the features described above, or as an alternative, further embodiments of the TOBI may include that an exit angle is defined between the trailing edge of the first TOBI airfoil and the trailing edge of the second TOBI airfoil at the exit.

In addition to one or more of the features described above, or as an alternative, further embodiments of the TOBI may include that the exit angle is 10° or less.

In addition to one or more of the features described above, or as an alternative, further embodiments of the TOBI may include that the TOBI body is one of additively manufactured or cast.

According to another embodiment, a gas turbine engine is provided. The gas turbine engine includes a tangential on-board injector (TOBI) having: a TOBI body, a first TOBI airfoil disposed within the TOBI body and having a radially extending portion extending from a leading edge and an axially extending portion extending toward a trailing edge such that a flow path along the first TOBI airfoil is radially flowing at the leading edge and is transitioned to circumferentially flowing at the trailing edge, and a second TOBI airfoil circumferentially adjacent to the first TOBI airfoil, the second TOBI airfoil having a radially extending portion extending from a leading edge and an axially extending portion extending toward a trailing edge such that a flow path along the second TOBI airfoil is radially flowing at the leading edge and is transitioned to circumferentially flowing at the trailing edge. An entrance defined between the leading edges of the adjacent TOBI airfoils and an exit defined between the trailing edges of the TOBI airfoils, wherein airflow entering the entrance enters in a radial direction relative to the TOBI body and airflow exiting the exit exits in a circumferential direction relative to the TOBI body.

In addition to one or more of the features described above, or as an alternative, further embodiments of the gas turbine engine may include a top wall and a bottom wall opposing the top wall, wherein the adjacent TOBI airfoils, the top wall, and the bottom wall define a passageway from the leading edges to the trailing edges.

In addition to one or more of the features described above, or as an alternative, further embodiments of the gas turbine engine may include that the entrance is defined by a first distance between the leading edges and the exit is defined by a second distance between trailing edges, wherein the first distance is greater than the second distance.

In addition to one or more of the features described above, or as an alternative, further embodiments of the gas turbine engine may include that the first TOBI airfoil and the second TOBI airfoil each have a uniform height such that the passageway has a uniform height extending from the entrance to the exit.

In addition to one or more of the features described above, or as an alternative, further embodiments of the gas turbine engine may include that an exit angle is defined between the trailing edge of the first TOBI airfoil and the trailing edge of the second TOBI airfoil at the exit.

In addition to one or more of the features described above, or as an alternative, further embodiments of the gas turbine engine may include that the exit angle is 10° or less.

In addition to one or more of the features described above, or as an alternative, further embodiments of the gas turbine engine may include that the TOBI body is one of additively manufactured or cast.

In addition to one or more of the features described above, or as an alternative, further embodiments of the gas turbine engine may include that the tangential on-board injector (TOBI) includes a plurality of three-dimensional swept airfoils.

According to another embodiment, a method of manufacturing a gas turbine engine having a tangential on-board injector (TOBI) is provided. The method includes forming a first TOBI airfoil within a TOBI body, the first TOBI airfoil having a radially extending portion extending from a leading edge and an axially extending portion extending toward a trailing edge such that a flow path along the first TOBI airfoil is radially flowing at the leading edge and is transitioned to circumferentially flowing at the trailing edge and forming a second TOBI airfoil circumferentially adjacent to the first TOBI airfoil, the second TOBI airfoil having a radially extending portion extending from a leading edge and an axially extending portion extending toward a trailing edge such that a flow path along the second TOBI airfoil is radially flowing at the leading edge and is transitioned to circumferentially flowing at the trailing edge. An entrance is defined between the leading edges of the adjacent TOBI airfoils and an exit is defined between the trailing edges of the TOBI airfoils, wherein airflow entering the entrance enters in a radial direction relative to the TOBI body and airflow exiting the exit exits in a circumferential direction relative to the TOBI body.

In addition to one or more of the features described above, or as an alternative, further embodiments of the method may include forming a top wall and a bottom wall opposing the top wall such that the adjacent TOBI airfoils, the top wall, and the bottom wall define a passageway from the leading edges to the trailing edges.

In addition to one or more of the features described above, or as an alternative, further embodiments of the method may include that the first TOBI airfoil and the second TOBI airfoil each have a uniform height such that the passageway has a uniform height extending from the entrance to the exit.

In addition to one or more of the features described above, or as an alternative, further embodiments of the method may include that the TOBI airfoils are formed by one of additive manufacturing or casting.

In addition to one or more of the features described above, or as an alternative, further embodiments of the method may include that the entrance is defined by a first distance between the leading edges and the exit is defined by a second distance between trailing edges, wherein the first distance is greater than the second distance.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1A is a schematic illustration of a portion of a gas turbine engine having a tangential on-board injector (“TOBI”);

FIG. 1B is a baseline view of the TOBI of FIG. 1A;

FIG. 1C, shows a top-down view of two adjacent passageways of the TOBI of FIG. 1A;

FIG. 2A is a first isometric schematic illustration of a tangential on-board injector in accordance with an embodiment of the present disclosure;

FIG. 2B is a second isometric schematic illustration of the tangential on-board injector of FIG. 2A; and

FIG. 2C is an isometric schematic illustration of a TOBI airfoil in accordance with an embodiment of the present disclosure.

### DETAILED DESCRIPTION

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in FIG. X may be labeled “Xa” and a similar feature in FIG. Z may be labeled “Za.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

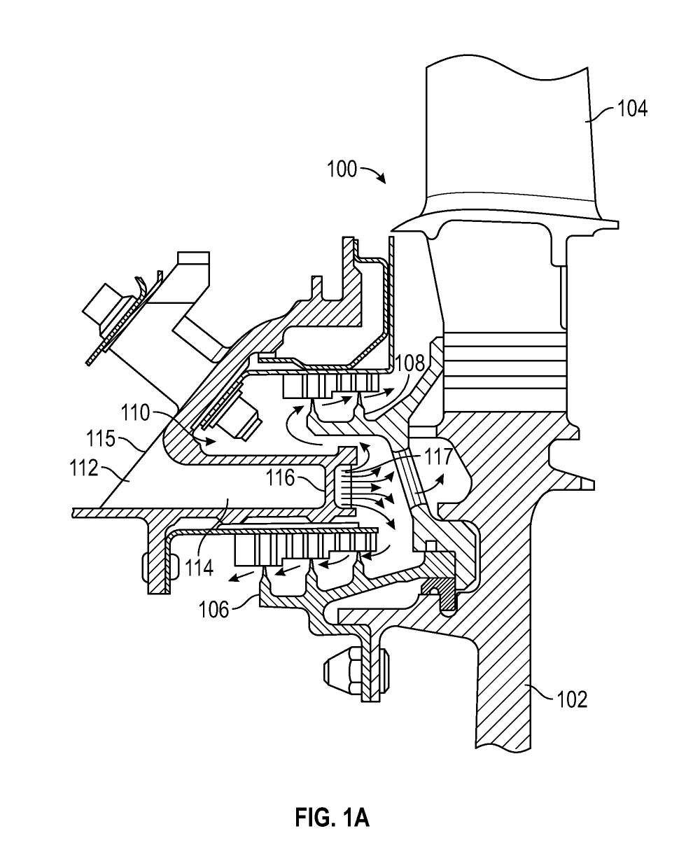

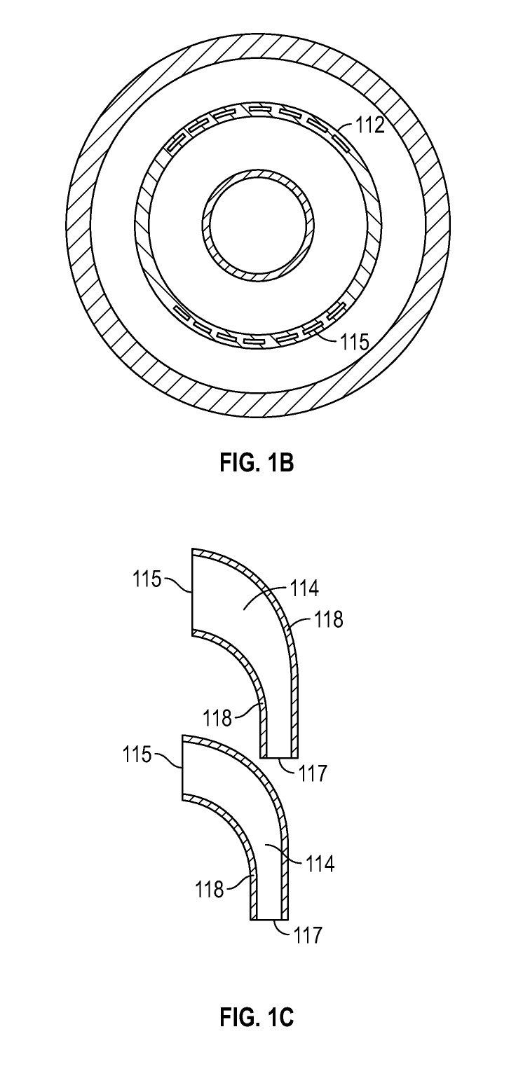

FIG. 1A is a schematic illustration of a portion of a gas turbine engine having a tangential on-board injector (“TOBI”). During operation, air discharging from the TOBI is delivered into a cavity just ahead of the turbine. The cavity is typically sealed off by one or more seals that interface between the rotating and non-rotating structure of the gas turbine engine. Air may escape or pass through the one or more seals in the form of leakage.

The arrows in FIG. 1A illustrate a cooling air flow discharging from the TOBI and distributed around and through a turbine portion of the gas turbine engine. As shown, a turbine 100 (partially shown) comprises a disk 102 supporting a plurality of circumferentially spaced blades 104 (one being shown). A first seal 106 and a second seal 108 are configured to define an annular cavity 110 just ahead of the turbine 100. A body 112 of a TOBI defines an annular passageway 114 that is configured to receive compressor discharge air and deliver it to the turbine rotor through a plurality of nozzles 116. The body 112 has an entrance 115 and an exit 117, with the nozzles 116 configured at the exit 117 of the body 112.

FIG. 1B is a baseline view of the TOBI of FIG. 1A. As shown, a plurality of entrances 115 may be formed in the body 112 of the TOBI. Although shown with entrances 115 covering 180° of the body 112 of the TOBI, those of skill in the art will appreciate that entrances 115 may cover the full 360° of the body of the TOBI, or other configurations may be employed. FIG. 1C, shows a top-down view of two circumferentially adjacent passageways 114 of the TOBI. As shown, the passageways 114 are defined between TOBI walls 118 which are configured to direct and control airflow through the body 112 of the TOBI.

In a conventional gas turbine engine, the configuration in FIGS. 1A-1C provide provides a flow metered by a static flow area with a predetermined tangential ejection angle relative to a rotor speed and current core flow rate through the TOBI. The static flow through the TOBI induces a monolithic pressure drop of the cooling flow it supplies to the airfoils downstream of the TOBI. The pressure ratio between the location just after ejection from the TOBI to a mid-span of a downstream airfoil generates a driving potential of cooling flow for the airfoil. For configurations utilizing a Variable Area Turbine (“VAT”), changes in vane area upstream of the airfoil can induce large fluctuations in the pressure ratio. The shifts in cooling pressure ration can impact back-flow-margin (e.g., an ability of a coolant to exit surface ejection holes) or a coolant flow rate to the airfoil. As provided herein, an adjustable TOBI (e.g., area changing) is provided to improve efficiency and/or operation of VAT in gas turbine engines.

Advantageously, TOBIs as provided herein may provide improved aerodynamic gas path through a TOBI to reduce pressure drop and maximize overall thermal efficiency of the TOBI through the application of TOBI airfoils with increased length and three-dimensional structure. For example, a three-dimensional swept airfoil in a TOBI can take advantage of the space forward and radially outboard of typical TOBI airfoils. However, advantageously, three-dimensional swept airfoils in TOBIs exist in the same axial space as prior configurations, but the three-dimensional swept airfoil has room for a better aerodynamic gas path.

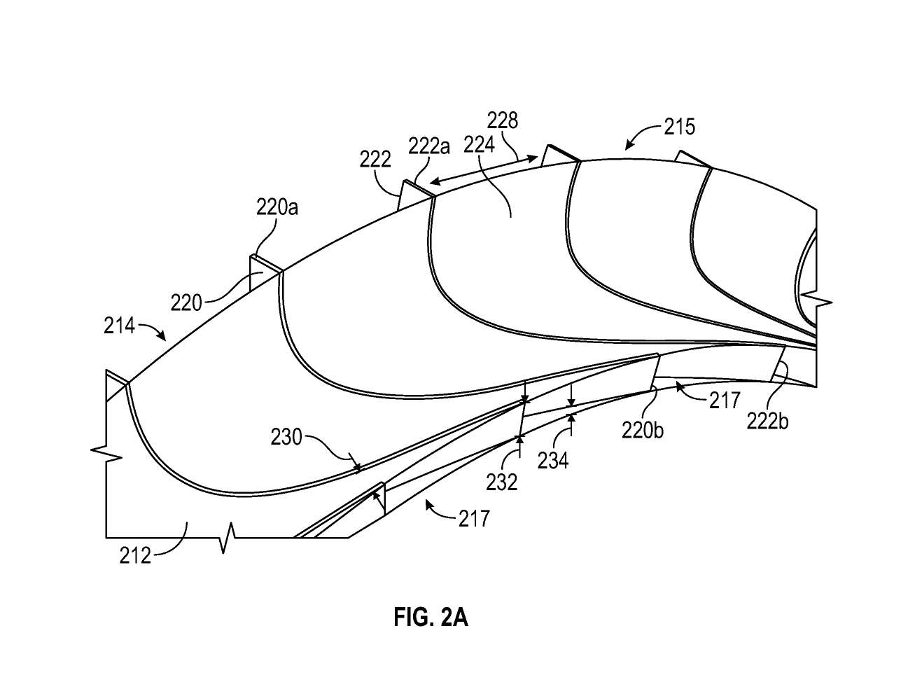

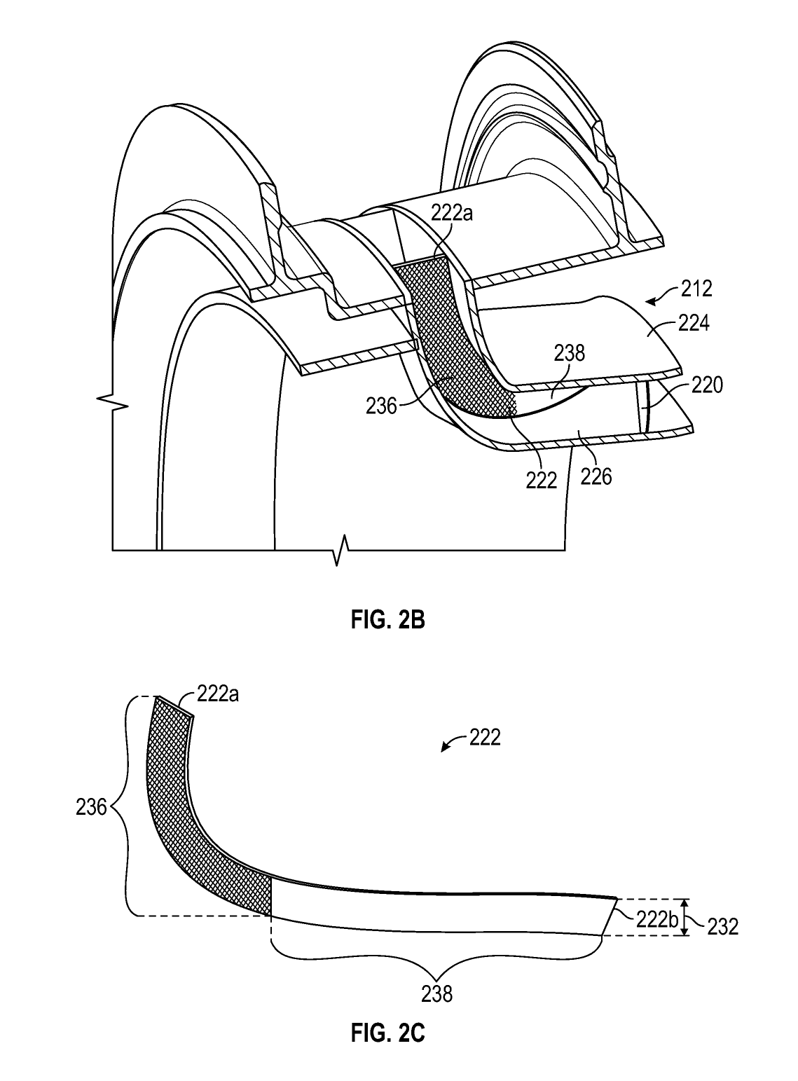

Turning now to FIGS. 2A-2C, schematic isometric illustrations of a three-dimensional swept airfoil for a TOBI in accordance with an embodiment of the present disclosure are shown. A TOBI body 212 having three-dimensional swept airfoils is shown. As used herein, the term “three-dimensional swept airfoil” means a TOBI airfoil that has a radially extending portion and an axially extending portion such that a flow surface along the airfoil from a leading edge to a trailing edge is directed radially and then axially as the airflow flows along a flow surface of the airfoil.

As shown in FIG. 2A, a first TOBI airfoil 220 and a second TOBI airfoil 222 are constrained between a top wall 224 and a bottom wall 226 of the TOBI body 212. The first TOBI airfoil 220 is circumferentially adjacent the second TOBI airfoil 222 within the TOBI body 212. The first TOBI airfoil 220 and the second TOBI airfoil 222 are separated by a first distance 228 at an entrance 215 and a second distance 230 at an exit 217. The entrance 215 is defined between leading edges 220a, 222b of the adjacent TOBI airfoils 220, 222 respective. Similarly, the exit 217 is defined between trailing edges 220b, 222b of the adjacent TOBI airfoils 220, 222.

Cooling air enters the TOBI body 212 radially at the entrance 215 between the adjacent TOBI airfoils 220, 222 and then flows radially downward/inboard and curves to flow axially toward the exit 217 through an annulus of the TOBI body 212. The annulus of the TOBI body 212 is a fluid cavity that extends from the entrance 215 to the exit 217 (e.g., along the length of the TOBI airfoils 220, 222 from the leading edges 220a, 222a to the trailing edges 220b, 222b). The airflow of the three-dimensional swept airfoils for TOBIs of the current disclosure is in contrast to, for example, the TOBI and airflow path of FIG. 1A, wherein the airflow is almost exclusively axial or horizontal, flowing from the entrance 115 to the exit 117. Because of the three-dimensional sweep of the TOBI airfoils 220, 222, the airfoil length can be increased without increasing an axial length of the TOBI body 212. Further, a longer airfoil allows a cooling airflow to fully develop, reducing pressure drop and improving thermal efficiency.

Each TOBI airfoil (222, 224) of the TOBI has a uniform height 232 and length (e.g., extending from respective airfoil leading edges 220a, 222b to airfoil trailing edges 220b, 222b). Accordingly, a plurality of flow paths can be formed within the TOBI body 212. As will be appreciated by those of skill in the art, each TOBI airfoil 220, 222 has defines two flow path sides that define walls of flow passages 214 through the TOBI body 212. The height 232 of the TOBI airfoils 220, 222 defines an annulus height of the flow passages 214 through the TOBI body 212. Further, in addition to having a second distance 230 at the exit 217, the exit 217 of each TOBI body includes an exit angle 234 between the trailing edges 220b, 222b of adjacent TOBI airfoils 220, 222. In some embodiments, the exit angle 234 is 10° or less.

The airflow through the TOBI body 212 enters the entrance 215 radially (e.g., flowing downward in FIGS. 2A-2B), and due to the three-dimensional sweep of the TOBI airfoils 220, 222, the airflow is directed downward into a narrower space (as the TOBI airfoils 220, 222 converge) and turned to flow circumferentially at the at exit 217 (e.g., at the trailing edges 220b, 222b). That is, the shape of the TOBI airfoils 220, 222 having a three-dimensional sweep enables improved airflow control, while maintaining a similar axial space as prior TOBI configurations. The cooling airflow that exits the TOBI body 212 at the exit 217 may be controlled by adjusting the annulus height 232, the second distance (exit spacing) 230, and the exit angle 234.

The three-dimensional sweep of the TOBI airfoils 220, 222 is defined by a radially extending portion and an axially extending portion of the TOBI airfoils. For example, as shown in FIGS. 2B-2C, a TOBI airfoil 222 has a radial extending portion 236, as indicated in cross-hatching, and an axial extending portion 238. Accordingly, as compared to prior TOBI airfoils, TOBI airfoils as provided herein are longer (i.e., from leading edge to trailing edge) and occupy previously unfilled space or volume. Those of skill in the art will appreciate that the radial extending portion 236 and the axial extending portion 238 define an airfoil body and thus the precise location where one portion ends and another begins can vary. Further, in some embodiments, the radially extending portion 236 includes the leading edge 222a (e.g., FIGS. 2B-2C), with the leading edge extending axially along its height. Similarly, the axially extending portion 238 includes the trailing edge 222b, with the trailing edge extending radially along its height.

As will be appreciated by those of skill in the art, TOBIs that are configured as described herein may be manufactured in a number of processes. For example, in some embodiments, the TOBI may be additively manufactured. However, in other embodiments, the TOBI may be machined, cast, or otherwise formed.

Advantageously, embodiments described herein provide a three-dimensional swept airfoil structure for a TOBI that enables a longer airflow path in an axial space that is similar to two-dimensional TOBI structures. Further, advantageously, embodiments provided herein enable improved cooling airflow, thermal cooling, and pressure drops.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments.

For example, although various shapes and configurations of three-dimensional swept airfoils for TOBIs are shown and described, those of skill in the art will appreciate that the shapes, sizes, etc. may be varied or modified as desired without departing from the scope of the present disclosure.

Accordingly, the present disclosure is not to be seen as limited by the foregoing description, but is only limited by the scope of the appended claims.

What is claimed is:

1. A tangential on-board injector (TOBI) for a gas turbine engine, the TOBI comprising:
a TOBI body;
a first TOBI airfoil disposed within the TOBI body and having a radially extending portion extending from a leading edge and an axially extending portion extending toward a trailing edge such that a flow path along the first TOBI airfoil is radially flowing at the leading edge and is transitioned to circumferentially flowing at the trailing edge; and
a second TOBI airfoil circumferentially adjacent to the first TOBI airfoil, the second TOBI airfoil having a radially extending portion extending from a leading edge and an axially extending portion extending toward a trailing edge such that a flow path along the second TOBI airfoil is radially flowing at the leading edge and is transitioned to circumferentially flowing at the trailing edge, and
an entrance is defined between the leading edges of the adjacent TOBI airfoils and an exit is defined between the trailing edges of the TOBI airfoils, wherein airflow entering the entrance enters in a radial direction relative to the TOBI body and airflow exiting the exit exits in a circumferential direction relative to the TOBI body.

2. The tangential on-board injector of claim 1, further comprising a top wall and a bottom wall opposing the top wall, wherein the adjacent TOBI airfoils, the top wall, and the bottom wall define a passageway from the leading edges to the trailing edges.

3. The tangential on-board injector of claim 2, wherein the entrance is defined by a first distance between the leading edges and the exit is defined by a second distance between trailing edges, wherein the first distance is greater than the second distance.

4. The tangential on-board injector of claim 2, wherein the first TOBI airfoil and the second TOBI airfoil each have a uniform height such that the passageway has a uniform height extending from the entrance to the exit.

5. The tangential on-board injector of claim 1, wherein an exit angle is defined between the trailing edge of the first TOBI airfoil and the trailing edge of the second TOBI airfoil at the exit.

6. The tangential on-board injector of claim 5, wherein the exit angle is 10° or less.

7. The tangential on-board injector of claim 1, wherein the TOBI body is one of additively manufactured or cast.

8. A gas turbine engine comprising:
a tangential on-board injector (TOBI) having:
a TOBI body;
a first TOBI airfoil disposed within the TOBI body and having a radially extending portion extending from a leading edge and an axially extending portion extending toward a trailing edge such that a flow path along the first TOBI airfoil is radially flowing at the leading edge and is transitioned to circumferentially flowing at the trailing edge; and
a second TOBI airfoil circumferentially adjacent to the first TOBI airfoil, the second TOBI airfoil having a radially extending portion extending from a leading edge and an axially extending portion extending toward a trailing edge such that a flow path along the second TOBI airfoil is radially flowing at the leading edge and is transitioned to circumferentially flowing at the trailing edge, and
an entrance defined between the leading edges of the adjacent TOBI airfoils and an exit defined between the trailing edges of the TOBI airfoils, wherein airflow entering the entrance enters in a radial direction relative to the TOBI body and airflow exiting the exit exits in a circumferential direction relative to the TOBI body.

9. The gas turbine engine of claim 8, further comprising a top wall and a bottom wall opposing the top wall, wherein the adjacent TOBI airfoils, the top wall, and the bottom wall define a passageway from the leading edges to the trailing edges.

10. The gas turbine engine of claim 9, wherein the entrance is defined by a first distance between the leading edges and the exit is defined by a second distance between trailing edges, wherein the first distance is greater than the second distance.

11. The gas turbine engine of claim 9, wherein the first TOBI airfoil and the second TOBI airfoil each have a uniform height such that the passageway has a uniform height extending from the entrance to the exit.

12. The gas turbine engine of claim 8, wherein an exit angle is defined between the trailing edge of the first TOBI airfoil and the trailing edge of the second TOBI airfoil at the exit.

13. The gas turbine engine of claim 12, wherein the exit angle is 10° or less.

14. The gas turbine engine of claim 8, wherein the TOBI body is one of additively manufactured or cast.

15. The gas turbine engine of claim 8, wherein the tangential on-board injector (TOBI) includes a plurality of TOBI airfoils.

16. A method of manufacturing a gas turbine engine having a tangential on-board injector, the method comprising:
forming a first TOBI airfoil within a TOBI body, the first TOBI airfoil having a radially extending portion extending from a leading edge and an axially extending portion extending toward a trailing edge such that a flow path along the first TOBI airfoil is radially flowing at the leading edge and is transitioned to circumferentially flowing at the trailing edge; and
forming a second TOBI airfoil circumferentially adjacent to the first TOBI airfoil, the second TOBI airfoil having a radially extending portion extending from a leading edge and an axially extending portion extending toward a trailing edge such that a flow path along the second TOBI airfoil is radially flowing at the leading edge and is transitioned to circumferentially flowing at the trailing edge, and
an entrance is defined between the leading edges of the adjacent TOBI airfoils and an exit is defined between the trailing edges of the TOBI airfoils, wherein airflow entering the entrance enters in a radial direction relative to the TOBI body and airflow exiting the exit exits in a circumferential direction relative to the TOBI body.

17. The method of claim 16, further comprising forming a top wall and a bottom wall opposing the top wall such that the adjacent TOBI airfoils, the top wall, and the bottom wall define a passageway from the leading edges to the trailing edges.

18. The method of claim 17, wherein the first TOBI airfoil and the second TOBI airfoil each have a uniform height such that the passageway has a uniform height extending from the entrance to the exit.

19. The method of claim 16, wherein the TOBI airfoils are formed by one of additive manufacturing or casting.

20. The method of claim 16, wherein the entrance is defined by a first distance between the leading edges and the exit is defined by a second distance between trailing edges, wherein the first distance is greater than the second distance.
